(19) United States
(12) Patent Application Publication
(10) Pub. No.: US 2016/0366850 A1
(43) Pub. Date: Dec. 22, 2016

(54) ANIMAL OCCUPANCY STRUCTURE

(71) Applicant: Edward S. Robbins, III, Muscle Shoals, AL (US)

(72) Inventor: Edward S. Robbins, III, Muscle Shoals, AL (US)

(21) Appl. No.: 14/971,900

(22) Filed: Dec. 16, 2015

Related U.S. Application Data
(63) Continuation-in-part of application No. 29/530,981, filed on Jun. 22, 2015, now Pat. No. D756041.

(51) Int. Cl. A01K 1/03

(52) U.S. Cl. CPC A01K 1/03

(57) ABSTRACT

An animal occupancy structure can include a vent, a cover and a base. The cover can include a planar surface and a cylindrical collar formed to extend perpendicularly from the planar surface and define an orifice therein. The vent can be coupled with the collar and is rotatable between a closed position in which the vent fully surrounds the collar and is nearest the planar surface, and an open position in which the vent only partially surrounds the collar and is spaced away from the planar surface. The base can be detachably coupled with the cover at a peripheral edge of the base and the cover. The base can include a uniformly concaved inner surface extending radially to the peripheral edge of the base to form an interior chamber between the base and the cover.

### PRIORITY

This application is a continuation-in-part of U.S. Design patent application Ser. No. 29/530,981, filed Jun. 22, 2015, which is incorporated herein by reference in its entirety.

### FIELD

This disclosure relates to a structure for animal occupancy.

### BACKGROUND

Enclosures for animal occupancy can provide a bed in which an animal can rest. In addition, such enclosures can provide walls and/or a roof to separate the animal from the environment surrounding the enclosure. For example, an outdoor animal enclosure can include walls and a roof that are impervious to weather, such as sun, rain and wind. Enclosures for animal occupancy can also provide a retention function to maintain the animal within the enclosure.

### SUMMARY

An animal occupancy structure is provided for indoor or outdoor use. The structure can include a base and a cover forming an enclosure and defining an interior chamber in which an animal may reside. The combination of the base and the cover can include an egress dimensioned to allow the animal to enter and exit the interior space. The base of the animal occupancy structure can be formed with a uniformly concaved interior floor surface extending to a peripheral edge of the base. The base can be formed to include a uniform radially extending first predetermined radius of curvature. The cover can be detachably coupled with the base and formed with an interior surface that includes a concave section and a planar section. The concave section can have a uniform and radially extending second predetermined radius of curvature and extend from a peripheral edge of the cover to the planar section of the cover. The first predetermined radius of curvature of the base can be greater than the second predetermined radius of curvature of the concave section. In addition, the uniformly concaved interior floor surface, the concave section, and the planar section can form the interior chamber. The animal occupancy structure can also include a vent detachably coupled with the planar section of the cover. The vent can be formed with a convex exterior surface having the second predetermined radius of curvature, and can be adjustable to selectively provide a variably sized channel for air to flow into and out of the interior chamber.

An interesting aspect of the animal occupancy structure relates to the cover including a planar surface and a cylindrical collar formed to extend perpendicularly from the planar surface and define an orifice therein. The vent can be coupled with the collar and is rotatable between a closed position in which the vent fully surrounds the collar and is nearest the planar surface, and an open position in which the vent only partially surrounds the collar and is spaced away from the planar surface.

Another interesting aspect of the animal occupancy structure relates to a plurality of struts independently coupled to an outer surface of the base. Each of the struts can extend away from the base in different directions at a same predetermined angle to form support legs for the animal occupancy structure. Each of the support legs can be of equal length and have a proximate end coupled with the base and a distal end formed to contact a surface, such as the ground, to maintain the base a predetermined distance from said surface. In addition, one of the base or the proximate end of each of the support legs can include a tab, and the other of the base or the proximate end of each of the support legs can include a slot formed to be receive the tab. Each of the support legs can be detachable coupled to the base at least by insertion of the respective tab in the respective slot.

Yet another interesting aspect of the animal occupancy structure relates to an example of the animal occupancy structure in which the base includes a convex outer surface opposite a corresponding concave concentrically formed inner surface forming a floor of the animal occupancy structure. In this example, the cover includes a planar inner surface opposite a corresponding planar outer surface, and a convex outer surface opposing a corresponding concave inner surface. The concave inner surface can concentrically extend between an outer peripheral edge of the cover and a transition that transitions to the planar inner surface and the planar outer surface. In this example configuration, the outer peripheral edge of the cover can be substantially circular and can be configured to detachable couple with an outer peripheral edge of the base, which can also be substantially circular.

The above, as well as other features and advantages, will become readily apparent to those skilled in the art from the following detailed description of a preferred embodiments when considered in the light of the accompanying drawings.

### BRIEF DESCRIPTION OF THE DRAWINGS

FIG. 1 is a perspective view of an example of an animal occupancy structure.

FIG. 2 is a front view of an example of the animal occupancy structure.

FIG. 3 is a perspective exploded view of an example of the animal occupancy structure.

FIG. 4 is a partial cutaway view of an example of a cover of the animal occupancy structure.

FIG. 5 is a partial cutaway view illustrating an example of a peripheral edge of a cover and a peripheral edge of a base and depicting an example coupling arrangement for the animal occupancy structure.

FIG. 6 is a cutaway side view of an example of a base of the animal occupancy structure.

FIG. 7 is a partial top view of an example of the base illustrated in FIG. 6.

FIG. 8 is an exploded bottom view of an example of a base separated from legs of the animal occupancy structure.

FIG. 9 is a bottom view of an example of a vent of the animal occupancy structure.

FIG. 10 is a perspective view of an example of a portion of a planar inner surface of a cover of the of the animal occupancy structure that includes a collar.

FIG. 11 is a perspective view of an example of a collar with a bracket positioned within a passageway between an interior chamber of the animal occupancy structure and a vent cap.

### DESCRIPTION OF PREFERRED EMBODIMENTS

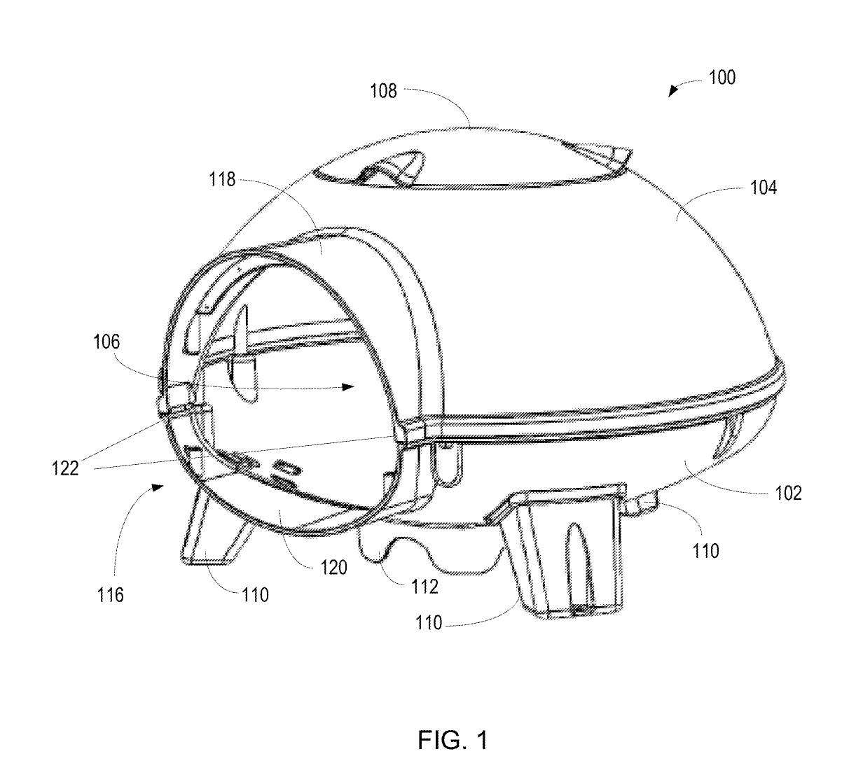

With reference to all the drawings, the same reference numerals are generally used to identify like components. FIG. 1 shows an example of animal occupancy structure 100. The animal occupancy structure 100 includes a base 102 detachably coupled to a cover 104 to form a shell defining an interior chamber 106. A vent 108 is coupled with the cover 104. The base 102 is elevated above a surface, such as a ground surface, by legs 110, which are coupled to an external surface of the base 102 and each extend away from the base 102 in a different direction. In the illustrated example, there are three legs 110 that operate as support piers under the base 102, however, in other examples additional or fewer legs may be present. Also coupled with the external surface of the base 102 can be a support frame 112 to provide additional structural support to the base 102.

Access to the interior chamber 106 may be via a passageway 116 formed by the base 102 and the cover 104. The cover 104 can include a first flange 118, and the base 102 can include a second flange 120 that cooperatively operate to provide the passageway 116 to the interior chamber 106. In the illustrated example, the first flange 118 and the second flange 120 can be formed as radially extending concaved surfaces having peripheral edges 122 that are contiguously aligned to form a cylindrical passage and provide access to the interior chamber 106.

The animal occupancy structure 100 may be made from any deformable material, such as plastic. In an example, the animal structure 100 may be formed by low pressure injection molding of a structural foam polymer such as thermal plastic polyurethane (TPU), polyethylene vinyl acetate (PVA) ethylene vinyl acetate (EVA), polyethylene (PE), polypropylene (PP), or polyvinyl chloride (PVC). In other examples, any other semi-rigid or rigid moldable material, such as plastic or thermoplastic may be used. The component parts of the animal occupancy structure 100 can be integrally formed as a unitary structure, or can be independent component parts that are coupled to form the animal occupancy structure 100 as also noted herein. The term “coupled” may refer to glue, ultrasonic welding, mechanical fasteners, snap-fit, friction fit or any other mechanism to rigidly attached to independent objects. The component parts of animal occupancy structure 100 can be manufactured in a range of thickness needed to provide structural support and integrity. In an example, the structure may be formed with plastic of uniform thickness such as in a range of about 0.2 inches to about 0.25 inches. In one example, the plastic may be a uniform thickness of about 0.22 inches.

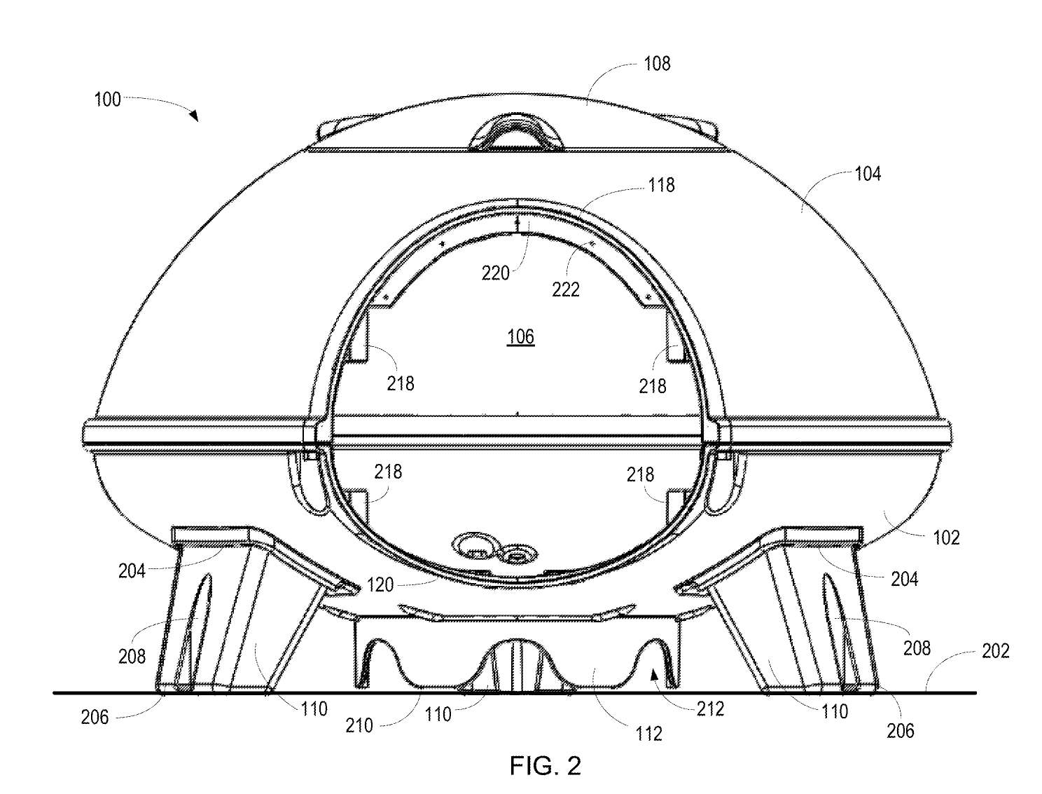

FIG. 2 is a front view of an example of the animal occupancy structure 100 positioned on a surface 202, such as a ground surface, such that each of the legs 110 are operable as support piers, or struts, to maintain the exterior surface of the base 102 separated away from the surface 202. As illustrated, a proximate end 204 of each of the legs 110 are contiguously coupled with the exterior surface of the base 102, and a distal end 206 of each of the legs 110 contact the surface 202. Due to the exterior surface of the base 102 having a radius of curvature, each of the legs 110 extend away from the base 102 in different directions. Each of the legs 110 may include a groove 208 formed to receive a hold down such as stake that can be driven into the surface 202 through an aperture at the distal end 206 of the respective leg 110 in order to fixedly maintain the animal occupancy structure 100 in a fixed position on the surface 202.

The support frame 112 can be a predetermined shape that is contiguously coupled with the exterior surface of the base 102 and extend toward the surface 202. In the illustrated example, the support frame 112 is a cylindrical structure that extends a predetermined distance toward the surface 202 such that an outer edge 210 of the support frame 112 is positioned above the surface 202. In other examples, the shape of the support frame 112 may be square, triangular, or may be separate channels. The example cylindrical structure of the support frame 112 includes a number of notches 212 and is of sufficient predetermined diameter to reinforce the base 102 from deflection when the base 102 is subject to a downward force toward the surface 202. In the event of a downward force being present in the interior chamber 106, such as from the presence of a large animal that deflects the base 102 toward the surface 202, the support frame 112 may come into contact with the surface 202 such that the support frame 112 may provide a support pier to maintain the base 102 separated away from the surface 202.

Each of the upper flange 118 and the lower flange 120 forming the passageway 116 may also include brackets 218 that are formed to receive doors or other form of closure device that allow access to the interior chamber 106 to be selectively blocked. For example, a wire mesh door may include top and bottom posts that are received in the brackets 218 on one side to form a hinge such that the door may swing open and closed, and the brackets 218 on the opposite side may receive some form of retractable locking mechanism, such as retractable spring loaded posts, so that the door can be secured in the closed position. The cover 104 may also include a bracket 220 from which a movable material may be suspended to block the passageway 116 to the interior chamber 106 from the external environment thereby creating a barrier to elements, such as heat, cold and wind, while being movable to allow entry into the interior chamber 106 by an animal. For example, a number of overlapping plastic strips of predetermined width and length may be suspended from the bracket 220 using fasteners mounted in apertures 222 to form a movable wall. U.S. Pat. No. 7,011,132 provides an example of a Strip Curtain Support System that can be used with the bracket 220.

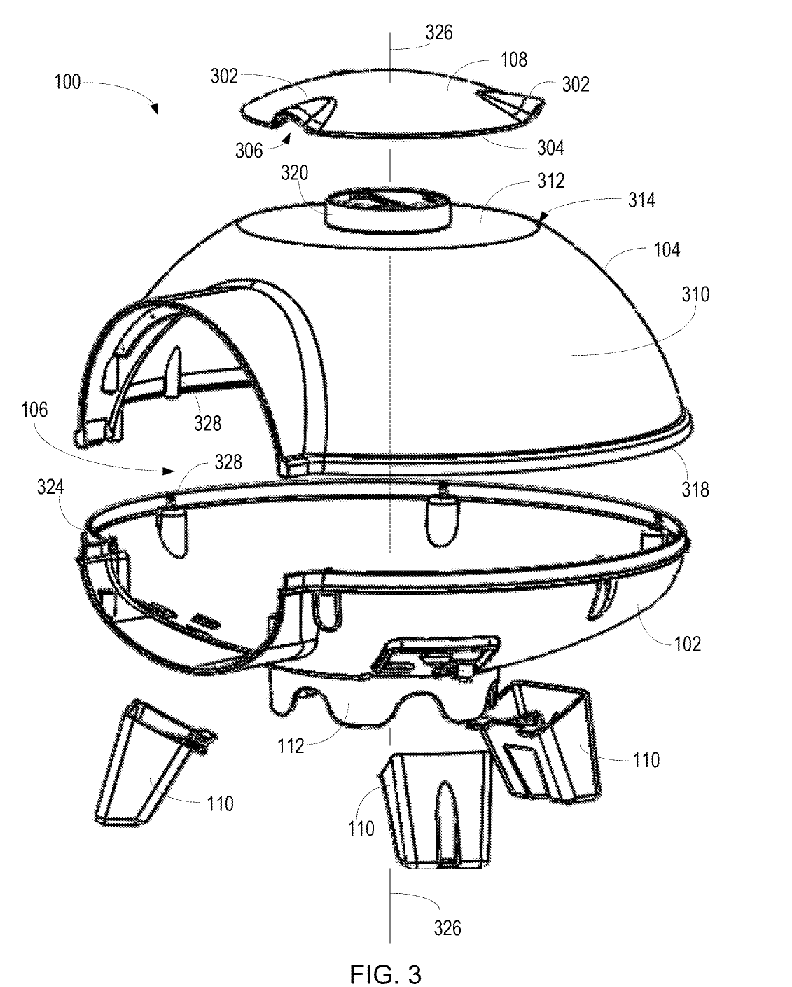

FIG. 3 is an exploded view of an example of the animal occupancy structure 100. The vent 108 includes a number of ears 302 that can be integrally formed with components of the vent 108 such that a peripheral edge 304 surrounding the vent 108 is continuously in the same plane, except where there are notches 306 due to the ears 302. In FIG. 3, the vent 108 is circular and the peripheral edge concentrically defines the diameter of the vent 108. The vent 108 can be formed with a convex outer surface opposing a concave inner surface. The convex outer surface can have a uniform predetermined radius of curvature.

The cover 104 includes a dome section 310 separated from a planar section 312 by a transition 314. The dome section 310, planar section 312, and the transition 314 may be integrally formed as a single unitary structure. The planar section 312 may include a collar 320 to which the vent 108 can be movably coupled to allow adjustment of a distance between the vent 108 and the cover 104 to selectively provide a variably sized channel for air to flow into and out of the interior chamber 106. In an example, the collar 320 can define an orifice in the cover 104.

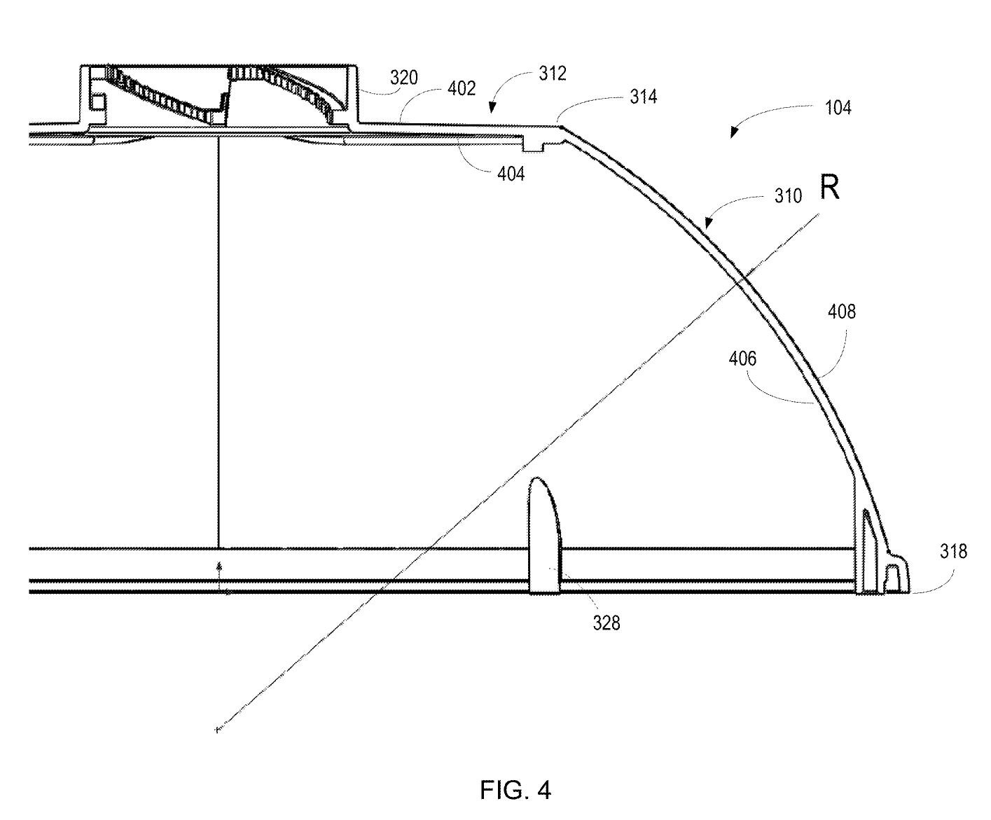

FIG. 4 is a cutaway partial side view of an example of the cover 104 of the animal occupancy structure 100. The planar section 312 may have a planar outer surface 402 and an opposing planar inner surface 404 that concentrically extend to the transition 314, and the dome section 310 may have a concave inner surface 406 and an opposing convex outer surface 408 that extend from the transition 314 to an outer peripheral edge 318 of the cover 104. The concave inner surface 406 may also be referred to as a concave section of the inner surface of the cover 104, and the convex outer surface 408 may be referred to as convex section of the outer surface of the cover 104. At least one of the concave inner surface 406 and the convex outer surface 408 included in the dome section 310 can have a uniform predetermined radius of curvature “R” and extends from the outer peripheral edge 318 of the cover 104 to the planar section 314. In an example, the radius of curvature “R” of the dome section 310 can be 16.20 inches. The planar outer surface 402 may be coupled with the collar 320 such that the collar 320 is perpendicular to the planar outer surface 402. The vent 108 is coupled with the collar 320 and can be configured to be rotatable between a closed position in which the vent 108 fully surrounds the collar 320 and is nearest the planar outer surface 402, and an open position in which the vent 108 only partially surrounds the collar 320 and is spaced away from the planar outer surface 402, The radius of curvature of the convex outer surface of the vent 108 may be substantially equal to the radius of curvature R of the dome section 310 so that outer convex surface 408 of the dome section 310 and the vent 108 form a substantially continuous surface when the vent 108 is adjusted to be next to the planar outer surface 402.

Referring again to FIG. 3, the base 102 can be coupled to the cover 104 such that the outer peripheral edge 318 of the cover 104 is detachably coupled with an outer peripheral edge 324 of the base 102. In an example, the peripheral edge 324 of the base 102 and the peripheral edge 318 of the cover 104 are each substantially circular and the base 102, the cover 104, and the vent 108 are concentrically positioned on a central axis 326. A number of fastener locations 328 may be included in the outer peripheral edge 318 of the cover 104 and the outer peripheral edge 324 of the base 102. Fasteners, such as bolts or screws may be cooperatively used with the fastener locations 328 to detachably couple the base 102 and the cover 104.

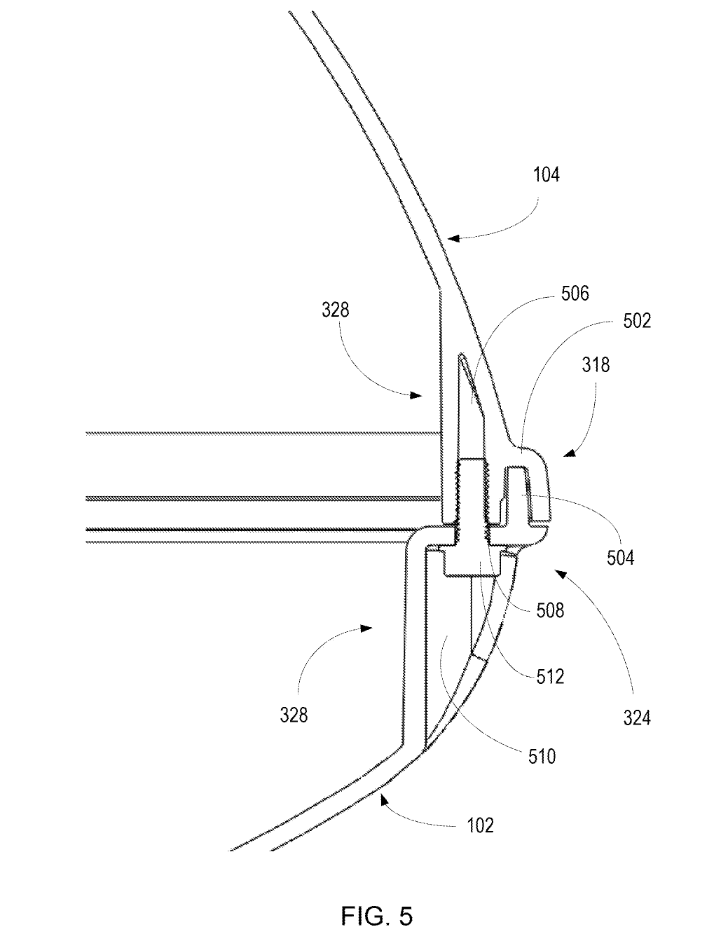

FIG. 5 is an example cutaway partial view of the peripheral edge 318 of the cover and the peripheral edge 324 of the base 102 illustrating an example coupling arrangement. In FIG. 5, the peripheral edge 318 of the cover 104 includes a channel 502, and the peripheral edge 324 of the base 102 includes a corresponding rib 504 that is formed to be received in the channel 502 and align the cover 104 and the base 102. In some examples, the channel 502 and the rib 504 extend around the entire periphery of the cover 104 and the base 102 respectively. In addition, the channel 502 and the rib 504 are sized to be closely coupled by friction fit to provide a barrier to external elements such as wind, rain or snow from entering the interior chamber 106. In this example, the fastener locations 328 include a fastener receiver 506 in the cover 104, and a fastener aperture 508 in the base 102. The base 102 may also include a depression 510 to allow access to the fastener aperture 508, so that a fastener 512, such as a bolt or screw, can be threaded into the fastener receiver 506 through the fastener aperture 508. In this example, the fastener receiver 506 is sized with a diameter substantially the same as the diameter of the fastener 512, in other examples, the fastener receiver 506 may include a bolt, a snap fit, a friction fit, or some other anchoring mechanism for the fastener 512. In addition, in other examples, the base 102 and cover 104 may be oppositely configured or may include only part of the indicated components, such as, for example, include only the channel 502 and the rib 504, or only the fastener receiver 506, the fastener aperture 508, and the fastener 512.

Referring again to FIG. 3, the base 102 is formed with a uniformly concaved interior floor surface that radially extends to the peripheral edge 324 of the base 102. The interior floor surface is concaved to provide a gentle sloping bowl shaped floor. The bowl shape floor can be concentrically formed with respect to the central axis 326 such that the peripheral edge 324 is at a higher elevation with respect to the part of the floor positioned at the central axis 326 so that any liquid present on the interior floor surface would flow by gravity to a drain hole present on the central axis to be discharged from the interior chamber 106.

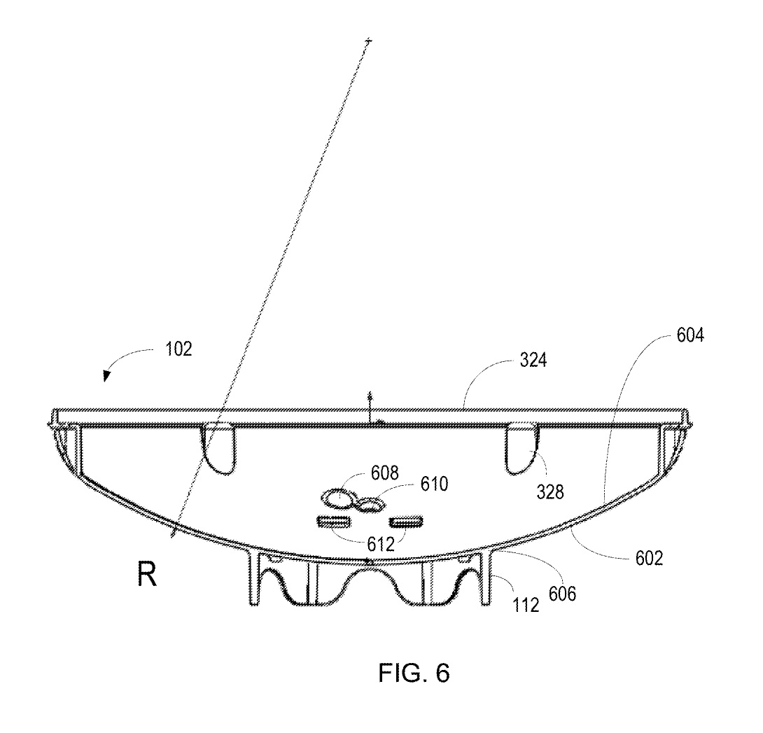

FIG. 6 is a cutaway side view of an example of the base 102 illustrating that the base 102 has a uniform predetermined radius of curvature “R”. In an example, the predetermined radius of curvature R of the base 102 is 26 inches. Accordingly, the radius of curvature R of the base 102 is greater than the radius of curvature R of the dome section 310 of the cover 104. In the illustrated example, the base 102 includes a convex outer surface 602 opposite a corresponding concave concentrically formed inner surface 604 forming a floor of the animal occupancy structure. Thus, the support frame 112, also illustrated in cross-section, is formed with a corresponding concave peripheral edge 606 to contiguously and continuously couple with the convex outer surface 602. In some examples, the support frame 112 can be integrally formed with the base 102 as a single unitary structure. The concave inner surface 604 may also include a first aperture 608, a second aperture 610, and a pair of apertures 612, which can be used, in some examples, to couple components to the base 102.

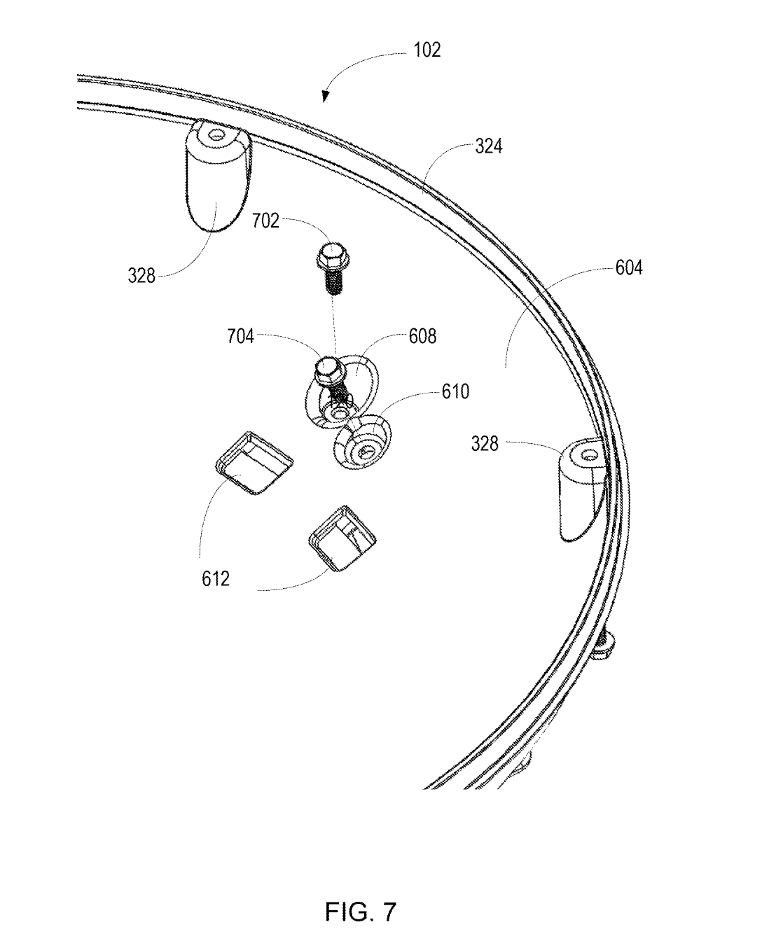

FIG. 7 is an example of a portion of the base 102 illustrating the concaved interior floor surface 604 that radially extends to the peripheral edge 324 of the base 102. In this example, a fastener 702, such as a thread bolt or screw may be inserted into the aperture 608 to rigidly hold in place an article, such as a mat or pad, on the concave inner surface 604 forming the floor. In addition, the aperture 610 may be formed to receive a fastener 704, such as a threaded bolt or screw.

The fastener 704, the aperture 610, and the pair of apertures 612 may be used as part of a coupling system to couple the legs 110 to the base 102. The article, such as the mat or pad, may be used to cover the apertures 608 and 610 and the pair of apertures 612, and may extend toward the outer peripheral edge 324. In some examples, the fastener locations 328 may be formed integrally with the base 102 (as illustrated in FIG. 7), and the cover 104, however, in other examples the fastener locations 328 may be coupled with the respective base 102 and cover 104.

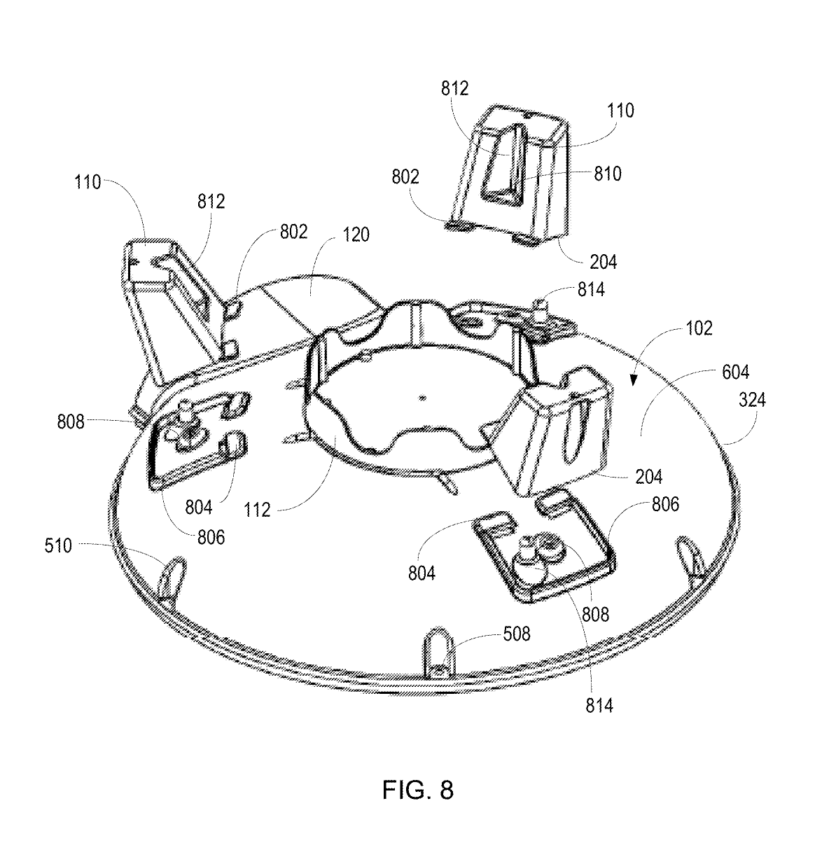

FIG. 8 is an exploded bottom view of an example of the base 102 separated from the legs 110. The base 102 and the legs 110 can be detachably coupled by a coupling system that includes a tab 802 and a slot 804. The tab 802 can be integrally formed as part of the legs 110, or fixedly coupled to the legs 110. The slot 804 can be integrally formed as part of the convex outer surface 604 so as to form the pair of apertures 612, or fixedly coupled to the convex outer surface 604. In addition, the coupling system can include one or more ribs 806 and a coupling receiver 808 formed with a predetermined diameter in the base 102 to fixedly receive a fastener, such as a threaded screw placed in the aperture 610. The slot 804 may be formed to receive the tab 802 and each leg 100 may be sized to fit within the ribs 806 and abut an outer surface of the legs 110 to arrest lateral movement of the legs 110 with respect to the base 102. The slot 804 and tab 802 may also cause at least part of the proximate end 204 of the legs to contiguously abut the outer convex surface 604 of the base 102. In other examples, the slot 804 may be formed in/coupled with the legs 110, and the tab 802 may be formed in/coupled with the base 102. In addition, in other examples, the ribs 806 may be stops, troughs, or other abutting mechanisms to arrest lateral movement.

Once the legs 110 are positioned within the ribs 806, and the tabs 802 and the slots 804 are coupled, a fastener 704 (FIG. 7) can be inserted through the aperture 610, and the fastener receiver 808 and be coupled with the respective legs 110. In an example configuration, each of the legs 110 includes a shelf 810 and a notch 812. The notch 812 may provide rigid structural support for the shelf 810, and the shelf 810 may include a receiver, such as an aperture formed to receive the fastener 704, and fixedly couple the legs 110 to the base 102. In an example, the shelf 810 provides a threaded connection or snap fit connection to receive the fastener 704. The base 102 may also include a receiver 814, as illustrated in FIG. 8, to receive the fastener 702 inserted through the aperture 608 (FIG. 7) formed in the concave concentrically formed inner surface 604 (FIG. 7) that forms a floor of the animal occupancy structure. The fastener 702 inserted through the aperture 608 in the floor and coupled with the receiver 814, such as by a threaded or snap fit connection, may be used to hold in place an article, such as a mat or pad, positioned on the concave inner surface 604 forming the floor.

Referring again to FIG. 3, the vent 108 can be detachably coupled with the planar section 312 of the body of the cover 104. The vent 108 can be formed with a concave interior surface having the second predetermined radius of curvature, and being adjustable to selectively provide a variably sized channel for air to flow into and out of the interior chamber 106. In an example, the peripheral edge 324 of the base 102 and the peripheral edge 318 of the cover 104 can each be circular and the vent 108 can be concentrically positioned coincident with the central axis 326 of the cover 104.

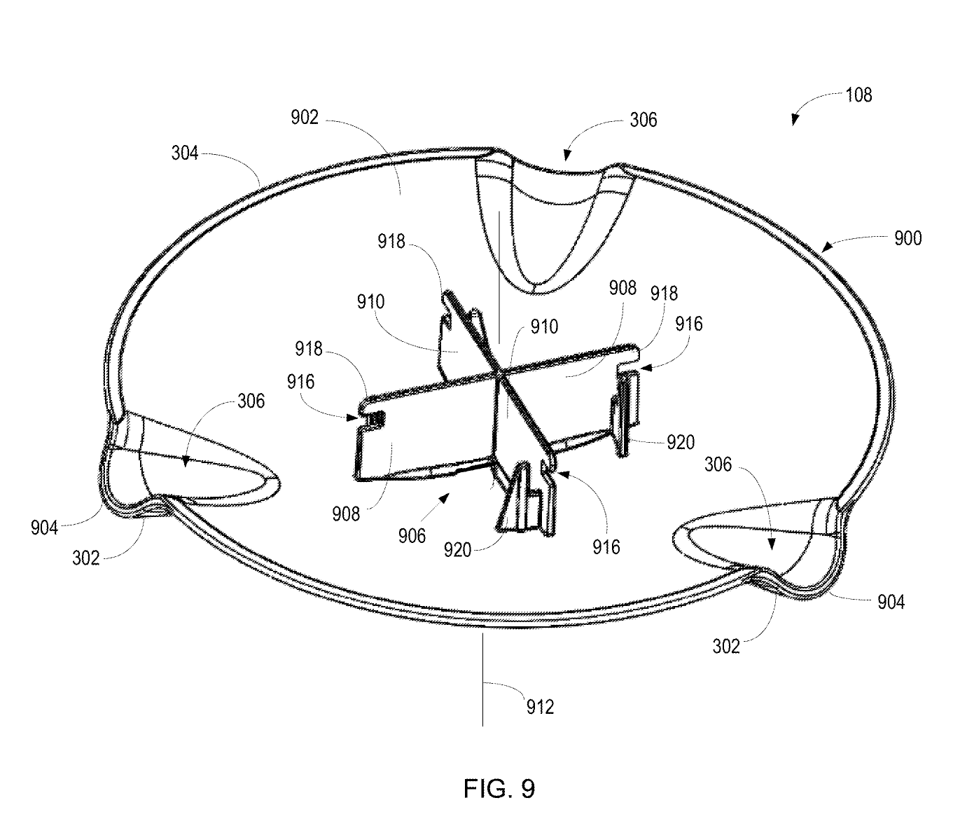

FIG. 9 is a bottom view of the vent 108 illustrating the positioning of the ears 302 symmetrically around the peripheral edge 304 of a vent cap 900 included as part of the vent 108. Due to the cooperative operation of the concaved interior surface 902 of the vent cap 900, and the ears 302, even when the vent 108 is adjusted to be contiguous with the outer planar surface 312 (FIG. 3), there can still be some air flow into and out of the interior chamber 106. Each of the ears 302 can be formed with multiple panels having different, or the same, radii of curvature to allow a smooth transition between the peripheral edge 304, the concave interior surface 902 of the vent cap 900, and an apex 904 of each of the ears 302.

The vent 108 can include a bracket 906 that is coupled with the concave surface 902 of the vent cap 900, or integrally formed with the vent cap 900. In FIG. 9, the bracket 906 includes first plates 908 lying in a first plane positioned perpendicular to second plates 910 lying in a second plane. In other examples, additional or fewer plates lying in additional or fewer planes are possible. The plates 908 and 910 are concentrically aligned with a central axis 912 of the vent 108, such that a proximate end of each of the plates 908 and 910 are coupled at the central axis 912, and the first and second planes intersect at the central axis 912. Each of the plates 908 and 910 include opposing planar surfaces, and extend away from the concave interior surface 902 a same predetermined distance. A distal end of each of the plates 908 and 910 is formed to include a slot 916 such that a finger 918 is formed at the distal end of the plates 908 and 910. In the example of FIG. 9, the slots 916 are formed as substantially rectangular, although in other examples, other shapes, such as circular and triangular slots are possible.

The plates 908 and 910 may be coupled with the concave interior surface 902, or may be integrally formed with the vent cap 900. The vent 108 may also include columns 920 that are coupled with the concave interior surface 902, or may be integrally formed with the vent cap 900. The columns 920 may also, or alternatively, be coupled with, or integrally formed with, the plates 908 and 910 to provide structural support at the distal end of the plates 908 and 910. In FIG. 9, the columns 920 are positioned adjacent to only one of the planar surfaces of the plates 908 and 910, and formed with a flange that fits in a slot included at the distal end of each of the plates 908 and 910 by friction fit to support the distal end of the plates 908 and 910.

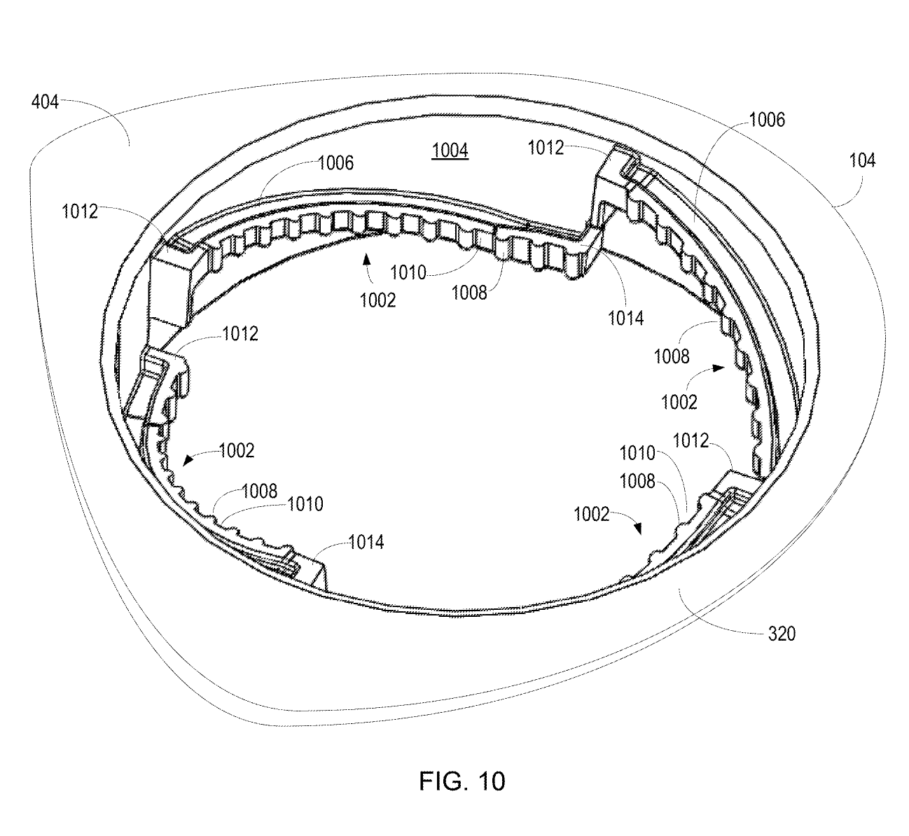

FIG. 10 illustrates a perspective view of an example of a portion of the planar inner surface 404 of the cover 104 that includes the collar 320 with the vent 108 removed (e.g. a bottom view) for purposes of clarity and explanation. The collar 320 can be a generally cylindrical structure defining an aperture providing a passageway between the vent 108 and the interior chamber 106. The collar 320 can include a number of helical rails 1002 coupled with an interior surface 1004 of the collar 320. In FIG. 10 there are four helical rails 1002, however, in other examples, fewer or greater numbers of helical rails 1002 may be included. Each of the helical rails 1002 are formed to provide a sloped track 1006 by which the fingers 918 of the bracket 906 (FIG. 9) can be slidable positioned along the helical rails 1002. The helical rails 1002 also include a sequence of uniformly formed shoulders 1008 spaced apart by a series of uniformly formed troughs 1010. The slots 916 included in the bracket 906 (FIG. 9) are formed to receive the portion of the helical rails 1002 that include the shoulders 1008 and troughs 1010, and allow the received portion of the helical rail 1002 to selectively slide through the slots 916 as the vent 108 is rotated in a series of steps defined by the shoulders 1008 and troughs 1010. Thus, each of the troughs 1010 can represent a stop where the bracket 906 is held in a rotatable position by the shoulders 1008 on either side of a respective trough 1010 in a respective step. Each of the helical rails 1002 can also include a top end stop 1012 and a bottom end stop 1014 that are formed to stop further slidable step-wise progress of the respective helical rails 1002 through the slots 916 as the vent 108 is rotated. Rotation of the vent 108 provides stepwise adjustment of the peripheral edge 304 of the vent 108 to move closer or further from the planar outer surface 402.

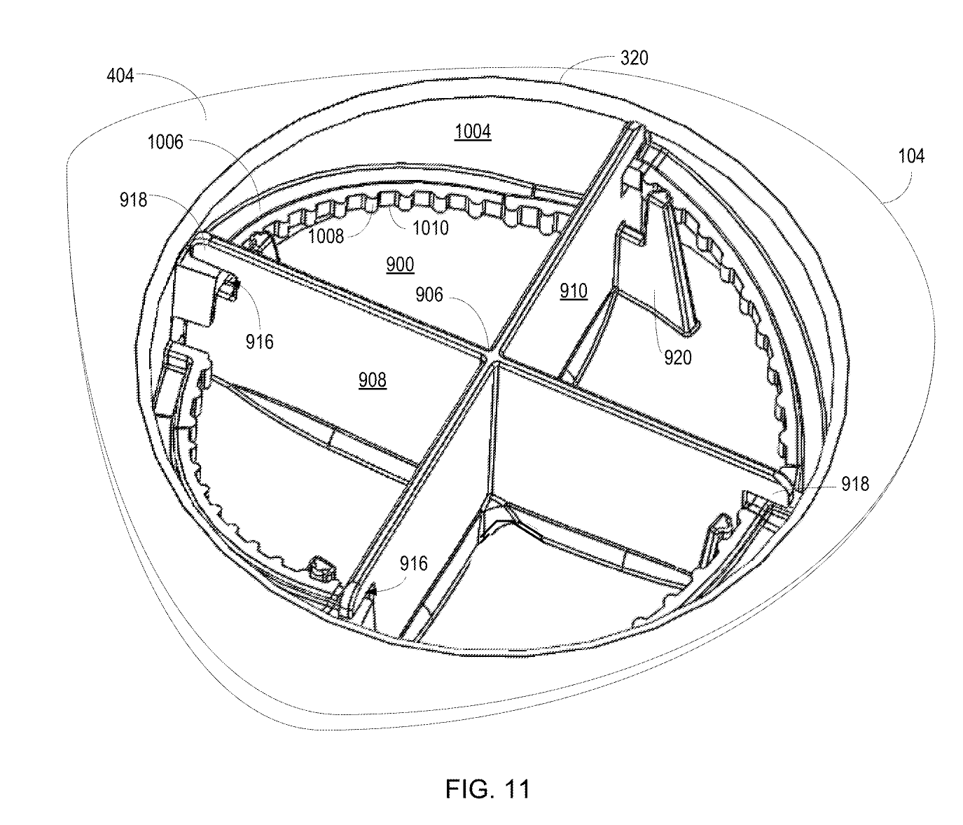

FIG. 11 is a perspective view of an example of a portion of the planar inner surface 404 of the cover 104 that includes the collar 320 with the vent 108 in place. In the example of FIG. 11, the collar 320 is illustrated with the bracket 906 positioned within the passageway to the interior chamber 106 and the vent cap 900 coupled with the bracket 906 above the collar 320. The bracket 906 is positioned in the collar 320 such that the fingers 918 are positioned on the sloped track 1006, and the slots 916 are partially surrounding a portion of the helical rails 1002. The collar 320 can be cylindrical and includes a plurality of steps formed on the interior wall 1004 of the collar 320 by the helical rails 1002. The vent 108 can rotatably engage with each of the steps to position the vent 108 at a different distance from the cover 104. More specifically, the bracket 906 is rotatable by, for example, a user grasping and manually rotating the vent cap 900 to each of the troughs 1010.

When rotated, the bracket 906 moves in a stepwise fashion between the shoulders 1008. The slots 916 may be held in any one of the troughs 1010 by the adjacent shoulders 108 to maintain the rotational and corresponding height position of the vent cap 900 thereby creating a stepwise adjustment. In FIG. 11, the vent 108 is illustrated as being rotated to the fully closed position (see also FIGS. 1 and 2) where the vent 108 fully surrounds the collar 320 and is nearest the planar surface 312. In the closed position, the plates 908 and 910 are abutted against the bottom end stops 1014 so that no further rotation of the vent 108 in the close direction is possible. By stepwise rotating the vent 108 in the opposite direction, the slots 916 in the bracket 906 can be selectively moved from trough 1010 to trough 1010 sequentially until the vent 108 reaches a desired position, or step, or until the vent 108 reaches the fully open position in which the vent 108 only partially surrounds the collar 320 and is spaced away from the planar surface 312.

While various embodiments have been described, it will be apparent to those of ordinary skill in the art that many more embodiments and implementations are possible within the scope of the disclosure. Accordingly, the invention is not to be restricted.

1. An animal occupancy structure comprising:
a base formed with a uniformly concaved interior floor surface extending to a peripheral edge of the base and having a first predetermined radius of curvature;
a cover detachably coupled with the base and formed with an interior surface having a concave section and a planar section, the concave section having a second predetermined radius of curvature and extending from a peripheral edge of the cover to the planar section, the first predetermined radius of curvature being greater than the second predetermined radius of curvature, wherein the uniformly concaved interior floor surface, the concave section and the planar section form an interior chamber; and
a vent detachably coupled with the planar section of the cover, the vent being formed with a convex exterior surface having the second predetermined radius of curvature, and being adjustable to selectively provide a variably sized channel for air to flow into and out of the interior chamber.

2. The animal occupancy structure of claim 1, wherein the peripheral edge of the base and the peripheral edge of the cover are each circular and the vent is concentrically positioned at a central axis of the cover.

3. The animal occupancy structure of claim 1, wherein the base and the cover are each formed as unitary structures.

4. The animal occupancy structure of claim 1, wherein the peripheral edge of the base is detachably coupled with the peripheral edge of the cover.

5. The animal occupancy structure of claim 1, wherein the planar section includes a collar, and the vent is rotatably coupled with the collar to be rotatably movable between a fully open position further away from the cover, and a fully closed position closer to the cover.

6. The animal occupancy structure of claim 5, wherein the collar is cylindrical and includes a plurality of steps formed on an interior wall of the collar, the vent rotatably engageable with each of the steps to position the vent at a different distance from the cover.

7. The animal occupancy structure of claim 1, further comprising a plurality of legs coupled with an exterior surface of the base and extending away from the base in different directions.

8. The animal occupancy structure of claim 1, further comprising a cylindrical frame coupled with an exterior surface of the base and extending away from the base opposite the cover.

9. An animal occupancy structure comprising:
a vent;
a cover comprising a planar surface and a cylindrical collar formed to extend perpendicularly from the planar surface and define an orifice therein, wherein the vent is coupled with the collar and is rotatable between a closed position in which the vent fully surrounds the collar and is nearest the planar surface, and an open position in which the vent only partially surrounds the collar and is spaced away from the planar surface; and
a base coupled with the cover at a peripheral edge of the base and the cover, the base comprising a uniformly concaved inner surface extending radially to the peripheral edge of the base to form an interior chamber between the base and the cover.

10. The animal occupancy structure of claim 9, further comprising a plurality of struts independently coupled to an outer surface of the base and extending away from the base in different directions at a same predetermined angle to form support legs for the animal occupancy structure.

11. The animal occupancy structure of claim 10, wherein each of the support legs are equal in length and have a proximate end coupled with the base and a distal end formed to contact a surface to maintain the base a predetermined distance from said surface.

12. The animal occupancy structure of claim 11, wherein one of the base or the proximate end of each of the support legs includes a tab, and the other of the base or the proximate end of each of the support legs includes a slot formed to be receive the tab, the support legs detachable coupled to the base at least by insertion of the respective tab in the respective slot.

13. The animal occupancy structure of claim 12, wherein the base comprises a rib coupled with an outer surface of the base, and an outer surface of the proximate end of each of the support legs is formed to contiguously engage the rib as a lateral support.

14. The animal occupancy structure of claim 9, further comprising a cylindrical support frame coupled with an outer surface of the base and concentrically aligned with a central axis of the base.

15. The animal occupancy structure of claim 9, wherein the cover further comprises a uniformly concaved inner surface that extends between the peripheral edge of the cover and a transition to the planar surface.

16. The animal occupancy structure of claim 15, wherein the cover comprises a first flange, and the base comprises a second flange, wherein the first flange and the second flange are formed as radially extending concaved surfaces having peripheral edges that are contiguously aligned to form a cylindrical passage and provide access to the interior chamber.

17. An animal occupancy structure comprising:
a base comprising a convex outer surface opposite a corresponding concave concentrically formed inner surface forming a floor of the animal occupancy structure;
a cover comprising a planar inner surface opposite a corresponding planar outer surface, and a convex outer surface opposing a corresponding concave inner surface concentrically extending between an outer peripheral edge of the cover and a transition that transitions to the planar inner surface and the planar outer surface;
the outer peripheral edge of the cover being substantially circular and configured to detachable couple with an outer peripheral edge of the base, the outer peripheral edge of the base being substantially circular; and
a vent coupled with the cover, the vent formed with a convex outer surface having a same radius of curvature as a radius of curvature of the convex outer surface of the cover.

18. The animal occupancy structure of claim 17, further comprising a plurality of struts formed as support piers, each of the struts comprising a distal end to contact a surface and a proximate end coupled independently with the base by a coupling system to be contiguously aligned with the base such that each of the struts extend away from the base in a different direction and are rigidly maintained from lateral movement.

19. The animal occupancy structure of claim 17, wherein the cover includes a collar coupled to the planar outer surface, and the vent is movably coupled with collar to allow adjustment of a distance between the vent and the planar outer surface.

20. The animal occupancy structure of claim 17, wherein the vent is coupled with a collar included in the cover, the collar including a helical rail upon which a bracket of the vent rotatably slides to adjust in a plurality of different steps a rotation of the vent, and a corresponding height of the vent above the cover.
